(19) United States
(12) Patent Application Publication
(10) Pub. No.: US 2022/0340120 A1
(43) Pub. Date: Oct. 27, 2022

(54) MOTOR VEHICLE

(71) Applicant: TOYOTA JIDOSHA KABUSHIKI KAISHA, Toyota-shi (JP)

(72) Inventors: Yudai HIJIKATA, Toyota-shi (JP); Chihiro KAMEYAMA, Nagoya-shi (JP)

(73) Assignee: TOYOTA JIDOSHA KABUSHIKI KAISHA, Toyota-shi (JP)

(21) Appl. No.: 17/685,510

(22) Filed: Mar. 3, 2022

(30) Foreign Application Priority Data
Apr. 22, 2021 (JP) 2021-072420

(51) Int. Cl. B60W 20/30; B60L 50/61; B60K 6/365; B60W 30/06; B60W 60/00

(52) U.S. Cl. CPC B60W 20/30; B60L 50/61; B60K 6/365; B60W 30/06; B60W 60/001; B60Y 2200/92; B60K 6/24

(57) ABSTRACT

A motor vehicle includes: an engine; an electric motor for traveling that is able to perform regenerative driving; a power storage device that is able to supply electric power to the electric motor and to be supplied with electric power from the electric motor; and a control device that controls autonomous driving including automated parking. Interruption control of causing a vehicle to stop and setting a shift position in a neutral range to interrupt autonomous driving is executed when a shift operation is performed during autonomous driving. The shift position is set in a parking range and autonomous driving is ended, and then the power storage device is charged using power from the engine, when a storage ratio of the power storage device reaches less than a predetermined ratio during interruption of autonomous driving that is performed through the interruption control.

### CROSS-REFERENCE TO RELATED APPLICATION

This application claims priority to Japanese Patent Application No. 2021-072420 filed on Apr. 22, 2021, incorporated herein by reference in its entirety.

### BACKGROUND

### 1. Technical Field

The present disclosure relates to a motor vehicle.

### 2. Description of Related Art

As a motor vehicle of this type, a motor vehicle has been proposed, in which the vehicle stops and the shift range of the transmission of the vehicle is set to the non-drive range when it is determined that the driving operation satisfies the override condition during automated parking (for example, see Japanese Unexamined Patent Application Publication No. 2018-144751 (JP 2018-144751 A)). The driving operation that satisfies the override condition is a driving operation other than the operation of decelerating the vehicle, that is, a driving operation other than the brake pedal operation, and corresponds to, for example, an accelerator pedal operation, a steering operation, a shift lever operation, and the like. In this motor vehicle, in the automated parking in which the shift range is automatically controlled, starting of the vehicle in a shift range different from the driver's assumption is suppressed through the above control.

### SUMMARY

However, in the above motor vehicle, in the case where the N range is set as the non-drive range, the system stops when the storage ratio of the battery decreases. In the neutral (N) range, starting the engine and generating electricity using the power of the engine are usually not allowed. Therefore, when the automated parking is interrupted in the N range and the storage ratio of the battery decreases, the system stops.

A main object of the motor vehicle of the present disclosure is to suppress a system stop due to a decrease in storage ratio of the power storage device even when autonomous driving including automated parking is interrupted in the N range.

The motor vehicle of the present disclosure has adopted the following means in order to achieve the above main object.

A motor vehicle of the present disclosure includes: an engine; an electric motor for traveling that is able to perform regenerative driving; a power storage device that is able to supply electric power to the electric motor and to be supplied with electric power from the electric motor; and a control device that performs autonomous driving control including automated parking. The control device executes interruption control of causing a vehicle to stop and setting a shift position in a neutral range to interrupt autonomous driving when a shift operation is performed during autonomous driving, and sets the shift position in a parking range and ends autonomous driving, and then charges the power storage device using power from the engine, when a storage ratio of the power storage device reaches less than a predetermined ratio during interruption of autonomous driving that is performed through the interruption control.

In the motor vehicle of the present disclosure, interruption control of causing a vehicle to stop and setting a shift position in a neutral range to interrupt autonomous driving is executed when a shift operation is performed during autonomous driving. The shift position is set in a parking range and autonomous driving is ended, and then the power storage device is charged using power from the engine, when a storage ratio of the power storage device reaches less than a predetermined ratio during interruption of autonomous driving that is performed through the interruption control. Thereby, it is possible to suppress a system stop due to a decrease in storage ratio of the power storage device even when autonomous driving including automated parking is interrupted in the neutral range.

In the motor vehicle of the present disclosure, the interruption control may be control that is executed when the shift operation is performed during automated parking. That is, the interruption control may be executed only when the shift operation is performed during automated parking.

The motor vehicle of the present disclosure may further include: a generator; and a planetary gear mechanism in which three rotating elements are connected to three axes including an output shaft of the engine, a rotating shaft of the generator, and a drive shaft connected to an axle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an outline of a configuration of a hybrid electric vehicle 20 as an embodiment of the present disclosure;

FIG. 2 is an explanatory diagram showing an example of the way in which the hybrid electric vehicle 20 of the embodiment is automatedly parked in a target parking space 100; and

FIG. 3 is a flowchart showing an example of an automated parking interruption process.

### DETAILED DESCRIPTION OF EMBODIMENTS

Hereinafter, modes for carrying out the present disclosure will be described using embodiments.

### Embodiments

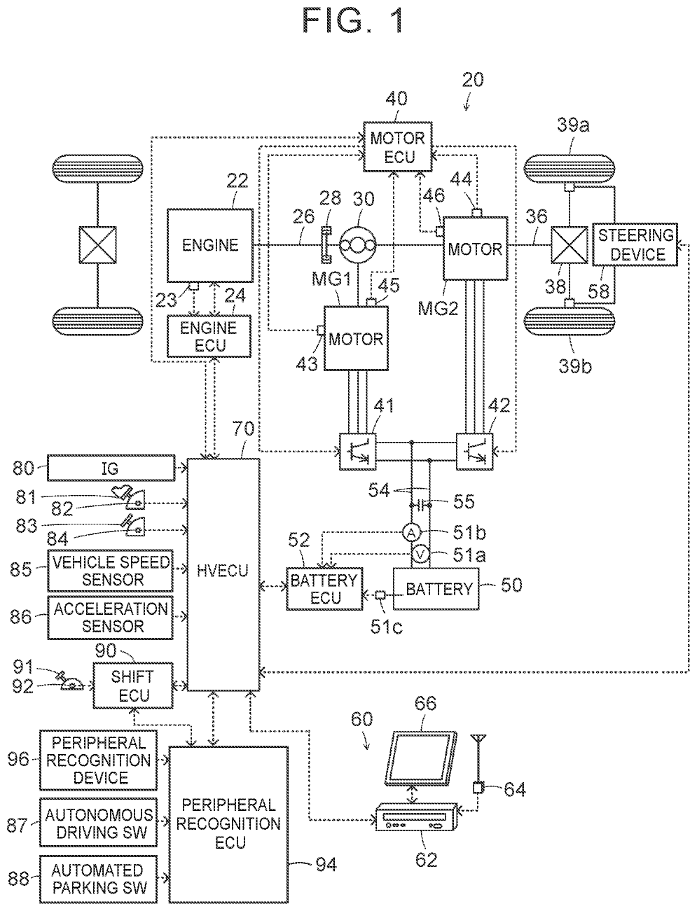

FIG. 1 is a configuration diagram showing an outline of a configuration of a hybrid electric vehicle 20 as an embodiment of the present disclosure. As shown in FIG. 1, the hybrid electric vehicle 20 of the embodiment includes an engine 22, a planetary gear 30, a motor MG1, a motor MG2, inverters 41 and 42, a battery 50 serving as a power storage device, a steering device 58, a navigation device 60, a hybrid vehicle electronic control unit (hereinafter referred to as “HV ECU”) 70, a shift electronic control unit (hereinafter referred to as “shift ECU”) 90, and a peripheral recognition electronic control unit (hereinafter referred to as “peripheral recognition ECU”) 94.

The engine 22 is configured as an internal combustion engine that outputs power using gasoline, light oil, or the like as fuel, and is connected to the carrier of the planetary gear 30 via a damper 28. Operation of the engine 22 is controlled by an engine electronic control unit (hereinafter referred to as “engine ECU”) 24.

Although not shown, the engine ECU 24 is configured as a microprocessor mainly including a central processing unit (CPU), and includes a read-only memory (ROM) for storing a processing program, a random access memory (RAM) for temporarily storing data, input and output ports, and a communication port, in addition to the CPU. Signals from various sensors necessary for controlling the operation of the engine 22 are input to the engine ECU 24 via the input port. Examples of the signals input to the engine ECU 24 include, for example, a crank angle Ocr from a crank position sensor 23 that detects the rotational position of a crankshaft 26 of the engine 22, and a coolant temperature Tw from a coolant temperature sensor that detects the temperature of the coolant of the engine 22. Examples of the signals further include an intake air pressure Pi from an intake air pressure sensor that detects an intake air pressure of the engine 22 and an intake air amount Qa from an air flow meter that detects an intake air amount of the engine 22. Various control signals for controlling the operation of the engine 22 are output from the engine ECU 24 via the output port. The engine ECU 24 calculates a rotation speed Ne of the engine 22 based on a crank angle Oc from the crank position sensor 23.

The planetary gear 30 is configured as a single pinion type planetary gear mechanism. A rotor of the motor MG1 is connected to the sun gear of the planetary gear 30. A drive shaft 36 connected to drive wheels 39a and 39b via a differential gear 38 is connected to the ring gear of the planetary gear 30. As described above, the crankshaft 26 of the engine 22 is connected to the carrier of the planetary gear 30 via the damper 28.

The motor MG1 is configured as, for example, a synchronous motor generator, and as described above, the rotor thereof is connected to the sun gear of the planetary gear 30. The motor MG2 is configured as, for example, a synchronous motor generator, and the rotor thereof is connected to the drive shaft 36. The inverters 41 and 42 are used for driving of the motors MG1 and MG2 and are connected to the battery 50 via a power line 54. A smoothing capacitor 55 is attached to the power line 54. The motors MG1 and MG2 are rotationally driven through switching control of a plurality of switching elements (not shown) of the inverters 41 and 42 by a motor electronic control unit (hereinafter referred to as “motor ECU”) 40.

Although not shown, the motor ECU 40 is configured as a microprocessor mainly including a CPU, and includes a ROM for storing a processing program, a RAM for temporarily storing data, input and output ports, and a communication port, in addition to the CPU. Signals from various sensors necessary for controlling the driving of the motors MG1 and MG2 are input to the motor ECU 40 via the input port. Examples of the signals input to the motor ECU 40 include rotational positions θm1 and θm2 from rotational position detection sensors 43 and 44 that detect the rotational positions of the rotors of the motors MG1 and MG2, motor temperatures Temp1 and Temp2 from temperature sensors 45 and 46 that detect the temperatures of the motors MG1 and MG2, phase currents from current sensors that detect the current flowing through each phase of the motors MG1 and MG2. Switching control signals and the like to the switching elements of the inverters 41 and 42 are output from the motor ECU 40 via the output port. The motor ECU 40 is connected to the HV ECU 70 via the communication port. The motor ECU 40 calculates rotation speeds Nm1 and Nm2 of the motors MG1 and MG2 based on the rotational positions θm1 and θm2 of the rotors of the motors MG1 and MG2 from the rotational position detection sensors 43 and 44.

The battery 50 is configured as, for example, a lithium ion secondary battery or a nickel metal hydride secondary battery, and is connected to the power line 54. The battery 50 is managed by a battery electronic control unit (hereinafter referred to as “battery ECU”) 52.

Although not shown, the battery ECU 52 is configured as a microprocessor mainly including a CPU, and includes a ROM for storing a processing program, a RAM for temporarily storing data, input and output ports, and a communication port, in addition to the CPU. Signals from various sensors necessary for managing the battery 50 are input to the battery ECU 52 via the input port. Examples of the signals input to the battery ECU 52 include a voltage Vb of the battery 50 from a voltage sensor 51a attached between the terminals of the battery 50, a current Ib of the battery 50 from a current sensor 51b attached to the output terminal of the battery 50, and a temperature Tb of the battery 50 from a temperature sensor 51c attached to the battery 50. The battery ECU 52 is connected to the HV ECU 70 via the communication port. The battery ECU 52 calculates a storage ratio SOC based on the integrated value of the current Ib of the battery 50 from the current sensor 51b, and calculates input and output limits Win and Wout based on the calculated storage ratio SOC and the temperature Tb of the battery 50 from the temperature sensor 51c. The storage ratio SOC is a ratio of the capacity of power that can be discharged from the battery 50 to the total capacity of the battery 50, and the input and output limits Win and Wout are allowable charge and discharge power that may be charged and discharged to and from the battery 50.

The steering device 58 includes a steering wheel (not shown) and the drive wheels 39a and 39b that are mechanically connected via a steering shaft, and includes a steering actuator. The steering device 58 performs steering based on the operation of the driver and steers the drive wheels 39a and 39b by driving the actuator based on the steering signal from the HV ECU 70.

The navigation device 60 includes a body 62 including a storage medium such as a hard disk storing map information and the like, input and output ports, and a control unit including a communication port, a Global Positioning System (GPS) antenna 64 that receives information on the current location of the own vehicle, and a touch panel display 66 that displays various kinds of information such as information on the current location of the own vehicle and a planned travel route to the destination, and allows the user to input various instructions. Here, in the map information, service information (for example, tourist information and parking lots), road information of each traveling section (for example, between traffic lights and between intersections), and the like are stored as a database. The road information includes distance information, road width information, information on the number of lanes, area information (urban areas and suburbs), road type information (general roads and highways), slope information, legal speed, the number of traffic lights, a turning radius of each curve, and the like. The navigation device 60 is connected to the HV ECU 70 via the communication port.

When the destination is set through the operation of the display 66 by the user, the body 62 of the navigation device 60 sets a planned travel route from the current location of the own vehicle to the destination, based on the map information stored in the body 62 and the current location of the own vehicle from the GPS antenna 64 and the destination, and provides a route guidance while displaying the set planned travel route on the display 66.

Although not shown, the HV ECU 70 is configured as a microprocessor mainly including a CPU, and includes a ROM for storing a processing program, a RAM for temporarily storing data, input and output ports, and a communication port, in addition to the CPU. Signals from various sensors are input to the HV ECU 70 via the input port. Examples of the signals input to the HV ECU 70 include an ignition signal from an ignition switch 80, an accelerator operation amount Acc from an accelerator pedal position sensor 82 that detects the depression amount of an accelerator pedal 81, a brake pedal position BP from a brake pedal position sensor 84 that detects the depression amount of a brake pedal 83, a vehicle speed V from a vehicle speed sensor 85, and an acceleration a from an acceleration sensor 86. As described above, the HV ECU 70 is connected to the engine ECU 24, the motor ECU 40, and the battery ECU 52 via the communication port.

Although not shown, the shift ECU 90 is configured as a microprocessor mainly including a CPU, and includes a ROM for storing a processing program, a RAM for temporarily storing data, input and output ports, and a communication port, in addition to the CPU. A shift position signal from a shift position sensor 92 that detects the operation position of the shift lever 91 is input to the shift ECU 90 via the input port. Examples of the shift position include a parking position (P range), a neutral position (N range), a drive position (D range), a reverse position (R range), and the like. The shift ECU 90 is connected to the HV ECU 70 and the peripheral recognition ECU 94 via the communication port. The shift ECU 90 sets the shift position based on the shift position signal from the shift position sensor 92 and the control signal from the peripheral recognition ECU 94 and transmits the set shift position to the HV ECU 70.

Although not shown, the peripheral recognition ECU 94 is configured as a microprocessor mainly including a CPU, and includes a ROM for storing a processing program, a RAM for temporarily storing data, input and output ports, and a communication port, in addition to the CPU. Information on the own vehicle and surroundings thereof from a peripheral recognition device 96 (for example, inter-vehicle distances D1 and D2 with respect to other vehicles in front of and behind the own vehicle and a traveling position of the own vehicle in the lane on the road surface) is input to the peripheral recognition ECU 94 via the input port. Examples of the peripheral recognition device 96 include a camera, a millimeter wave radar, a quasi-millimeter wave radar, an infrared laser radar, a sonar, and the like. Examples of the peripheral recognition device 96 further include an autonomous driving mode switch signal from an autonomous driving switch 87 for setting an autonomous driving mode, an automated parking switch signal from an automated parking switch 88 operated when performing automated parking, and the like. The autonomous driving switch 87 and the automated parking switch 88 are attached to the steering wheel or the instrument panel in front of the driver seat, or the vicinity thereof. The peripheral recognition ECU 94 is connected to the HV ECU 70 and the shift ECU 90 via the communication port.

In the hybrid electric vehicle 20 of the embodiment configured as described above, through coordinated control of the HV ECU 70, the engine ECU 24, and the motor ECU 40, the engine 22 and the motors MG1 and MG2 are controlled such that the hybrid electric vehicle 20 travels while switching between the electric vehicle traveling (EV traveling) of traveling without operation of the engine 22 and the hybrid vehicle traveling (HV traveling) of traveling with the operation of the engine 22. Since the drive control in the hybrid electric vehicle 20 of the embodiment during the EV traveling and the HV traveling is well known, detailed description thereof will be omitted.

In the autonomous driving mode, the HV ECU 70 controls the vehicle speed V based on the planned travel route, the current location of the own vehicle, and the map information (for example, legal speed) from the navigation device 60 and the information on the own vehicle and surroundings thereof from the peripheral recognition device 96, and controls the steering device 58 such that lane keeping and lane changing are performed, regardless of whether the EV traveling or the HV traveling.

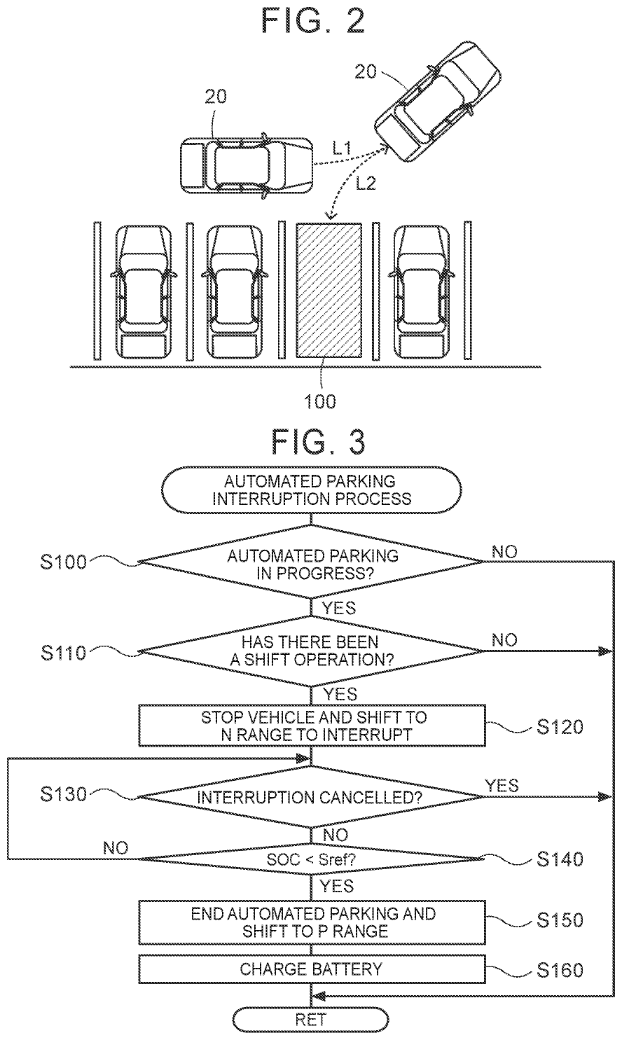

Automated parking based on the operation of the automated parking switch 88 is performed, for example, when the brake pedal 83 is depressed and the vehicle is stopped, and the automated parking switch 88 is operated while the shift position SP is in the D range. FIG. 2 shows an example of the way in which the hybrid electric vehicle 20 of the embodiment is automatedly parked in a target parking space 100. The automated parking is performed as follows. First, the driver sets, as the target parking space 100, a parking space recognized by the peripheral recognition device 96 and displayed with hatching on the display 66, and sets a parking direction of whether to park backward or forward in the target parking space 100. FIG. 2 shows a case of parking backwards. Subsequently, when the target parking space 100 and the parking direction are set, target routes L1 and L2 for parking the hybrid electric vehicle 20 in the target parking space 100 are set. Then, the shift position SP, the motor MG2 (vehicle speed V), the steering device 58 (steering), and the like are controlled such that the hybrid electric vehicle 20 travels along the target routes L1 and L2 and parks in the target parking space 100. In this case, control of the shift position SP is performed by the shift ECU 90 based on the instruction from the peripheral recognition ECU 94. Control of the motor MG2 and the steering device 58 is performed by the HV ECU 70 based on the information from the peripheral recognition ECU 94.

Next, the operation of the hybrid electric vehicle 20 of the embodiment thus configured, particularly the operation when the automated parking is interrupted will be described. FIG. 3 is a flowchart showing an example of an automated parking interruption process. This routine is repeatedly executed during the automatic parking until the automated parking is ended. Execution of this routine is shared by HV ECU 70, the shift ECU 90, and the peripheral recognition ECU 94.

In the automated parking interruption process, first, it is determined whether the automated parking is in progress (step S100). This determination can be made by whether the automated parking switch signal from the automated parking switch 88 is on. When it is determined that the automated parking is not in progress, it is determined that the process is unnecessary, and the process is terminated.

When it is determined in step S100 that the automated parking is in progress, it is determined whether there has been a shift operation (step S110). This determination can be made based on the shift position signal from the shift position sensor 92. When it is determined that there has been no shift operation, it is determined that the process is unnecessary, and the process is terminated.

When it is determined in step S110 that there has been a shift operation, traveling of the hybrid electric vehicle 20 is stopped, and the shift position SP is shifted to the N range regardless of the operation position of the shift lever 91 to interrupt the automated parking (step S120). Shifting the shift position SP to the N range is performed by the shift ECU 90 based on the control signal from the peripheral recognition ECU 94. Subsequently, it is determined whether the storage ratio SOC of the battery 50 has reached less than a threshold value Sref without cancellation of the interruption of the automated parking (steps S130 and S140). Cancellation of the interruption of the automated parking can be performed, for example, by selecting resumption or cancellation of the automated parking that are displayed on the display 66. The threshold value Sref is determined in advance as the storage ratio necessary for the next system startup, and for example, 15% or 20% can be used. When it is determined that the interruption of the automated parking has been canceled by the time when the storage ratio SOC of the battery 50 reaches less than the threshold value Sref, the automated parking is resumed, and thus the process is terminated.

When it is determined in steps 5130 and 5140 that the storage ratio SOC of the battery 50 has reached less than the threshold value Sref without cancellation of the interruption of the automated parking, the automated parking is ended and the shift position SP is shifted to the P position (step S150), the battery 50 is charged (step S160), and the process is ended. Shifting of the shift position SP to the P range is performed by the shift ECU 90 based on the control signal from the peripheral recognition ECU 94. The battery 50 can be charged by starting the engine 22 and using the power from the engine 22 to cause the motor MG1 to function as a generator. The battery 50 may be charged until the storage ratio SOC of the battery 50 reaches a predetermined storage ratio that is larger than the threshold value Sref (for example, 25%, 30%, 40%, and the like).

When the shift operation is performed during automated parking, the hybrid electric vehicle 20 of the embodiment described above stops, the shift position SP is shifted to the N range, and the automated parking is interrupted. Then, when the storage ratio SOC of the battery 50 reaches less than the threshold value Sref without cancellation of the interruption of the automated parking, the automated parking is ended and the shift position SP is shifted to the P position and the battery 50 is charged. As a result, even when the automated parking is interrupted, it is possible to suppress a system stop due to a decrease in the storage ratio SOC of the battery 50.

In the hybrid electric vehicle 20 of the embodiment, the automated parking is ended and the shift position SP is shifted to the P position, and the battery 50 is charged, when the storage ratio SOC of the battery 50 reaches less than the threshold value Sref without cancellation of the interruption of the automated parking during the interruption of the automated parking based on the shift operation during the automated parking. However, a configuration may be adopted in which the autonomous driving is ended and the shift position SP is shifted to the P position, and the battery 50 is charged, when the storage ratio SOC of the battery 50 reaches less than the threshold value Sref without cancelation of the interruption of the autonomous driving while the interruption of the autonomous driving based on the shift operation during the autonomous driving continues.

In the embodiment, the present disclosure is applied to the hybrid electric vehicle 20 including the engine 22, the motor MG1, the motor MG2, and the planetary gear 30. However, the present disclosure can be applied to a motor vehicle having any configuration as long as the motor vehicle is capable of automated parking and the battery thereof can be charged when the shift position SP is in the P range.

In the embodiment, control is performed by the plurality of electronic control units such as the HV ECU 70, the engine ECU 24, the motor ECU 40, the battery ECU 52, the shift ECU 90, and the peripheral recognition ECU 94, as the control device. However, the control may be performed by a single electronic control unit, or a plurality of electronic control units.

The correspondence between the main elements of the embodiment and the main elements of the disclosure described in the summary will be described. In the embodiment, the engine 22 corresponds to the “engine”, the motor MG2 corresponds to the “electric motor”, the battery 50 corresponds to the “power storage device”, the HV ECU 70, the engine ECU 24, the motor ECU 40, the battery ECU 52, the shift ECU 90, and the peripheral recognition ECU 94 correspond to the “control device”. Further, the motor MG1 corresponds to the “generator” and the planetary gear 30 corresponds to the “planetary gear mechanism”.

The correspondence between the main elements of the embodiment and the main elements of the disclosure described in the summary is an example for specifically describing the modes for carrying out the disclosure described in the summary through the embodiment. Therefore, the correspondence does not limit the elements of the disclosure described in the summary. That is, the disclosure described in the summary should be interpreted based on the description therein, and the embodiment is merely a specific example of the disclosure described in the summary.

Although the modes for carrying out the present disclosure have been described above with reference to the embodiment, the present disclosure is not limited to the embodiment, and needless to say, the present disclosure can be implemented in various modes without departing from the scope of the present disclosure.

The present disclosure can be used in the motor vehicle manufacturing industry and the like.

What is claimed is:

1. A motor vehicle comprising:
an engine;
an electric motor for traveling that is able to perform regenerative driving;
a power storage device that is able to supply electric power to the electric motor and to be supplied with electric power from the electric motor; and
a control device that performs autonomous driving control including automated parking, wherein the control device
executes interruption control of causing a vehicle to stop and setting a shift position in a neutral range to interrupt autonomous driving when a shift operation is performed during autonomous driving, and
sets the shift position in a parking range and ends autonomous driving, and then charges the power storage device using power from the engine, when a storage ratio of the power storage device reaches less than a predetermined ratio during interruption of autonomous driving that is performed through the interruption control.

2. The motor vehicle according to claim 1, wherein the interruption control is control that is executed when the shift operation is performed during automated parking.

3. The motor vehicle according to claim 1, further comprising:
a generator; and
a planetary gear mechanism in which three rotating elements are connected to three axes including an output shaft of the engine, a rotating shaft of the generator, and a drive shaft connected to an axle.
